(19) United States
(12) Patent Application Publication
(10) Pub. No.: US 2013/0339573 A1
(43) Pub. Date: Dec. 19, 2013

(54) OPTIMIZING WRITE PERFORMANCE TO FLASH MEMORY

(71) Applicants: Clark A. Anderson, Rochester, MN (US); Edward W. Chencinski, Poughkeepsie, NY (US); Jon S. Entwistle, Las Vegas, NV (US); Adrian C. Gerhard, Rochester, MN (US); Thomas J. Griffin, Salt Point, NY (US); Charles E. Mari, Wappingers Falls, NY (US); Kenneth J. Oakes, Wappingers Falls, NY (US); Steven M. Partlow, Beacon, NY (US); Peter G. Sutton, Poughkeepsie, NY (US); Elpida Tzortzatos, Lagrangeville, NY (US); Dustin J. VanStee, Poughkeepsie, NY (US)

(72) Inventors: Clark A. Anderson, Rochester, MN (US); Edward W. Chencinski, Poughkeepsie, NY (US); Jon S. Entwistle, Las Vegas, NV (US); Adrian C. Gerhard, Rochester, MN (US); Thomas J. Griffin, Salt Point, NY (US); Charles E. Mari, Wappingers Falls, NY (US); Kenneth J. Oakes, Wappingers Falls, NY (US); Steven M. Partlow, Beacon, NY (US); Peter G. Sutton, Poughkeepsie, NY (US); Elpida Tzortzatos, Lagrangeville, NY (US); Dustin J. VanStee, Poughkeepsie, NY (US)

(73) Assignee: INTERNATIONAL BUSINESS MACHINES CORPORATION, Armonk, NY (US)

(21) Appl. No.: 13/524,484

(22) Filed: Jun. 15, 2012

(51) Int. Cl. G06F 12/02

(52) U.S. Cl. 711/103; 711/E12.008

(57) ABSTRACT

Embodiments relate to optimizing write performance of a flash device. Aspects include receiving a request to evict a plurality of pages from a main memory and determining a block size for the flash device. Aspects also include grouping the plurality of pages from the main memory into a move specification block, wherein a size of the move specification block is the block size and writing the move specification block to the flash device. The block size being determined based on one or more operational characteristics of the flash device.

### BACKGROUND

The present invention relates generally to flash memory, and more specifically, to optimizing the performance of write operations in flash memory.

The process of selecting which memory pages to displace from central storage and transfer to auxiliary storage is called page stealing, or page replacement. Pages of memory stored in real storage may need to be transferred to auxiliary storage depending on real storage usage patterns and the need for real storage by critical or high priority work. The pool of auxiliary storage available to the system may include a mixture of storage mediums, such as flash memory and direct access storage devices (DASD) storing for example, paging data sets. Each of these storage mediums may have varying and unique performance characteristics. For example, while flash memory SSD (solid state drive) latency for random access reads outperforms traditional HDD (hard disk drive) latency, both throughput and latency on write operations are comparable to HDDs that include a large DRAM cache. In addition, flash technology is often characterized by complex operating characteristics that may radically affect the performance of flash devices.

The difference in performance between a flash device that is accessed in a manner that has been optimized to the characteristics of the technology and one accessed without that optimization is substantial. Proper optimization of the access method of flash storage can make the difference between the flash device being superior in performance or inferior in performance to an HDD with a large cache.

### SUMMARY

Embodiments include a method, system, and computer program product for optimizing write performance of a flash device. Aspects include receiving a request to evict a plurality of pages from a main memory and determining a block size for the flash device. Aspects also include grouping the plurality of pages from the main memory into a move specification block, wherein a size of the move specification block is the block size, and writing the move specification block to the flash device.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 illustrates a block diagram of a system in accordance with an exemplary embodiment;

FIG. 2 depicts a block diagram of system for optimizing the performance of writing to a flash memory in accordance with an exemplary embodiment;

FIG. 3 depicts a process flow for a method of optimizing the performance of writing to a flash memory in accordance with an exemplary embodiment;

FIG. 4 depicts a graph illustrating the effect of block size on write operations in a flash device; and

FIG. 5 illustrates a computer program product in accordance with an embodiment.

### DETAILED DESCRIPTION

In exemplary embodiments, write performance to flash memory is improved both in terms of latency and throughput for writes to flash memory. In exemplary embodiments, the operating system organizes its data pages that are selected for eviction from main memory during page replacement for optimal throughput and latency when written to a flash device. The method of organizing the data pages is optimized to the operating technology characteristics of the flash device, exploiting its strengths and accounting for its weaknesses, to insure that the maximum benefits of the technology can be exploited.

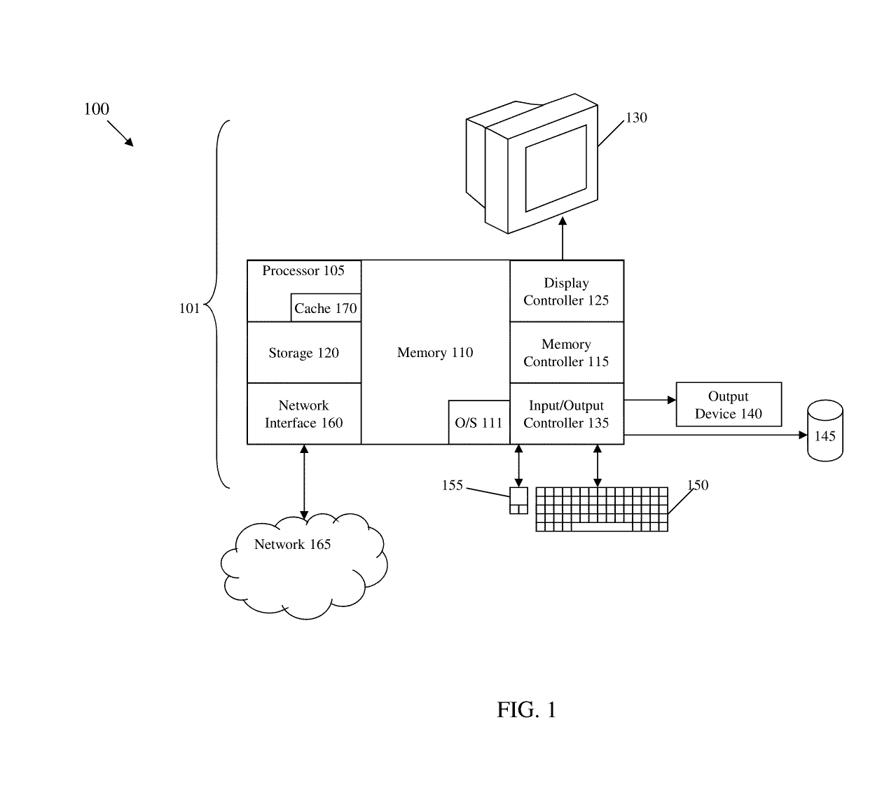

FIG. 1 illustrates a block diagram of an exemplary computer system 100 for use with the teachings herein. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 1, the computer 101 includes a processor 105, memory 110 coupled via a memory controller 115, a storage device 120, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The storage device 120 may include one or more hard disk drives (HDD), solid state drives (SSD), or any other suitable form of storage.

The processor 105 is a computing device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 may include a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

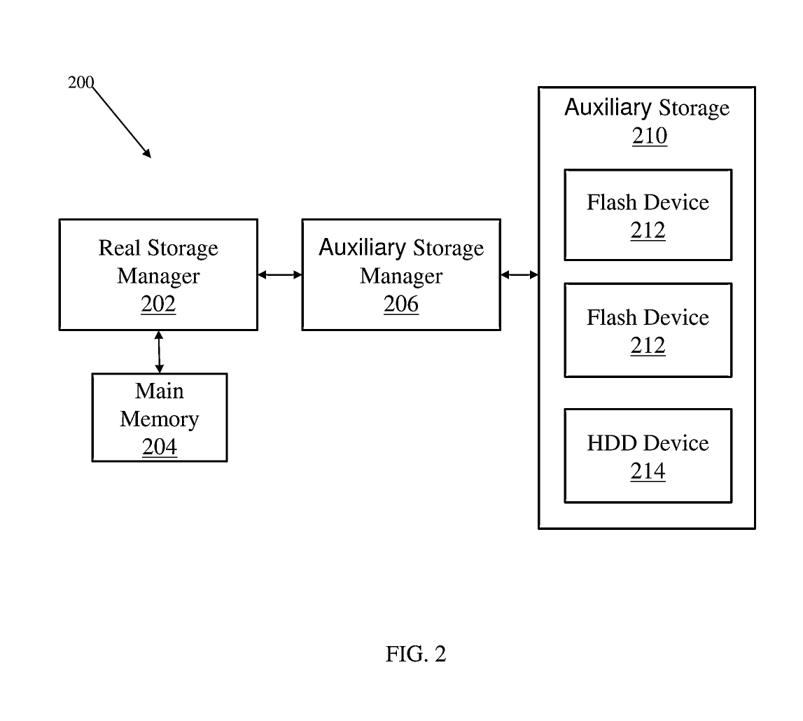

Referring now to FIG. 2, a block diagram of system 200 for optimizing the performance of writing to a flash device in accordance with an exemplary embodiment is shown. As illustrated, the system 200 includes a real storage manager 202 that is in communication with and configured to manage a main memory 204. The system 200 also includes an auxiliary storage manager 206 that is in communication with and configured to manage an auxiliary storage 210. In exemplary embodiments, the auxiliary storage 210 may include a variety of storage devices including, but not limited to, one or more flash devices 212, a HDD 214 and the like.

In exemplary embodiments, the real storage manager 202 is configured to select a set of pages to evict from the main memory 204 and to call the auxiliary storage manager 206 to write content of the selected pages to the auxiliary storage 210. In exemplary embodiments, the auxiliary storage manager 206 is configured to choose a location in the auxiliary storage 210 to store the content of the selected pages. After selecting a location in the auxiliary storage 210, such as the flash device 212, the auxiliary storage manager 206 initiates an I/O operation to write the selected pages to the flash device. Upon completion of the I/O operation the auxiliary storage manager 206 notifies the real storage manager 202 that the I/O operation is complete.

In exemplary embodiments, when the operating system or application writes a set of selected pages to flash device 212 that reside in non-contiguous main memory 204 the auxiliary storage manager 206 is configured to group the pages together and write the group to flash device 212 at a block size and uniformity that will optimize the performance of the flash device 212. The block size that will optimize the performance of the flash device 212 can vary for different flash devices 212. In exemplary embodiments, the block size may be 128K, 256K, 1 MB or the like. In exemplary embodiments, the auxiliary storage manager 206 is configured to utilize the locality of reference for pages in deciding what pages should be combined, or aggregated, for a write operation.

In exemplary embodiments, when the auxiliary storage manager 206 receives a request to move a set of pages from the main memory 204 to auxiliary storage 210, the auxiliary storage manager 206 will aggregate these pages into the consistent, optimal size chunks (For example, 1 MB blocks, which each include of 256 4K pages) and write these pages as a single write I/O. In addition, the data pages will be written to occupy contiguous address space in the auxiliary storage device, such as the flash device 212.

In exemplary embodiments, the real storage manager 202 may evict pages from the main memory 204 during page replacement in order to improve the performance of write paging operations involving a flash device 212. In this case, the auxiliary storage manager 206 will use an virtual address, for example a extended asynchronous indirect data mover address words (AIDAWs), for all output I/O operations in order to write dis-contiguous pages from the main memory 204 to contiguous locations in the flash device 212. The extended asynchronous data mover (EADM) is an extension to the channel subsystem that allows a program to request the transfer of blocks of data between main memory 204 and auxiliary storage 210.

In exemplary embodiments, the auxiliary storage manager 206 uses a single move specification block when using AIDAWs. As used herein the term, move specification block refers to a unit of information that controls the flow of to/from auxiliary storage 210, also referred to as storage class memory (SCM), and main memory. The move specification block specifies: the starting address of the AIDAW list; the starting auxiliary storage address for the group of pages; and the number of entries in the AIDAW list.

In exemplary embodiments, the consistent use of one move specification block and AIDAW will significantly reduce the amount of time required to write a set of pages to the flash device as compared with using separate move specification blocks for each page. Flash device technology includes a complex management algorithm which creates the appearance of a uniform solid state drive, while performing numerous data movement operations in the background. The background processing performed by the flash devices causes highly variable access delays. As a result of the background processing being preformed by the flash device, a write of a block of data of a specific size can vary tremendously depending on other writes that have occurred during the hours preceding the write of interest. In general, the highest throughput write operations are the largest sequential block writes, when performed in an array that has exclusively been written with large blocks in the past. A large block write that is performed after many small block writes have been performed is actually not much faster than the small block writes themselves. Accordingly, if the auxiliary storage manager 206 is not configured to account for the operational characteristics of the flash device 212 and allows the flash device 212 to be polluted with small block writes, the flash device 212 will have a far larger latency and lower throughput.

Flash devices include complex management algorithms which include constant read-modify-write activity. Every time that data is written to a flash device, data stored on the flash device is moved, check bits are adjusted and also written. Flash devices also include ‘garbage collection’ algorithms that operate in the background and free up data blocks by moving and pooling data blocks. If small block writes are done for hours, the entire flash device can become organized over time on a small block basis. Then, when a large block write then occurs, the background algorithm must free up enough small blocks so that it can aggregate them into a large block to provide a place for the incoming data to be written. This background process quickly comes to dominate the performance of the flash device when a burst of large block writes occurs after a drive is preconditioned with a long period of small block writes. In exemplary embodiments, by ensuring that all data writes to the flash device are done in ideal block sizes the degradation of the behavior of the storage technology related to background processing can be overcome.

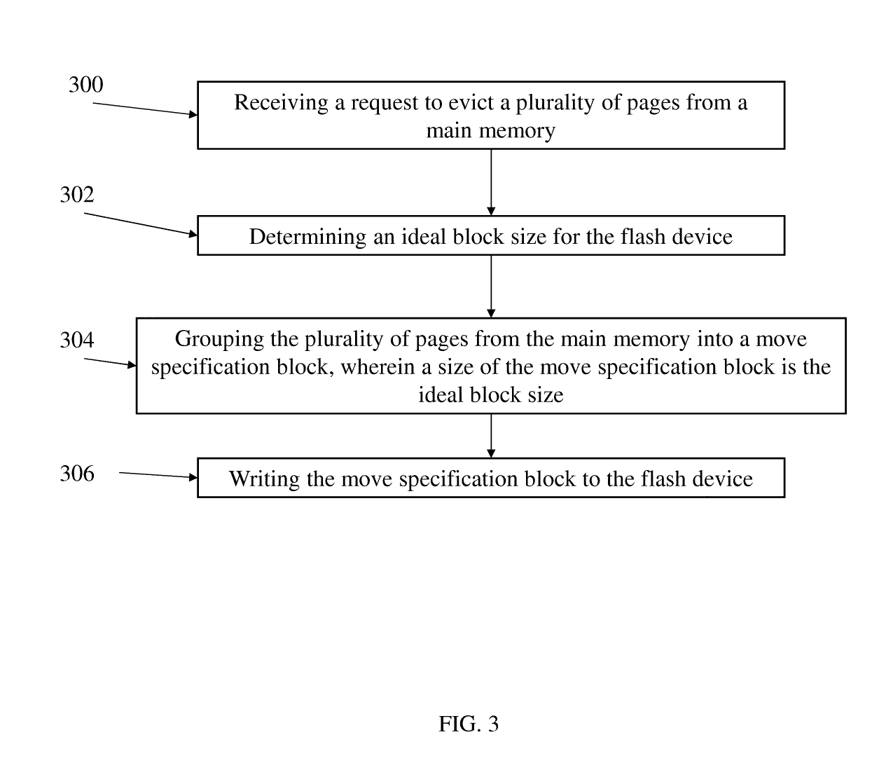

Referring now to FIG. 3, a process flow for a method of optimizing the performance of writing to a flash memory in accordance with an exemplary embodiment is shown. As illustrated at block 300, the method includes receiving a request to evict a plurality of pages from a main memory. Next, the method includes determining an ideal block size for the flash device, as illustrated at block 302. As shown at block 304, the method includes grouping the plurality of pages from the main memory into a move specification block that is the ideal block size. Next, as shown at block 306, the method includes writing the move specification block to the flash device. In exemplary embodiments, an auxiliary storage may include multiple flash devices that may have different ideal block sizes, which are determined based on the operational characteristics of the flash device.

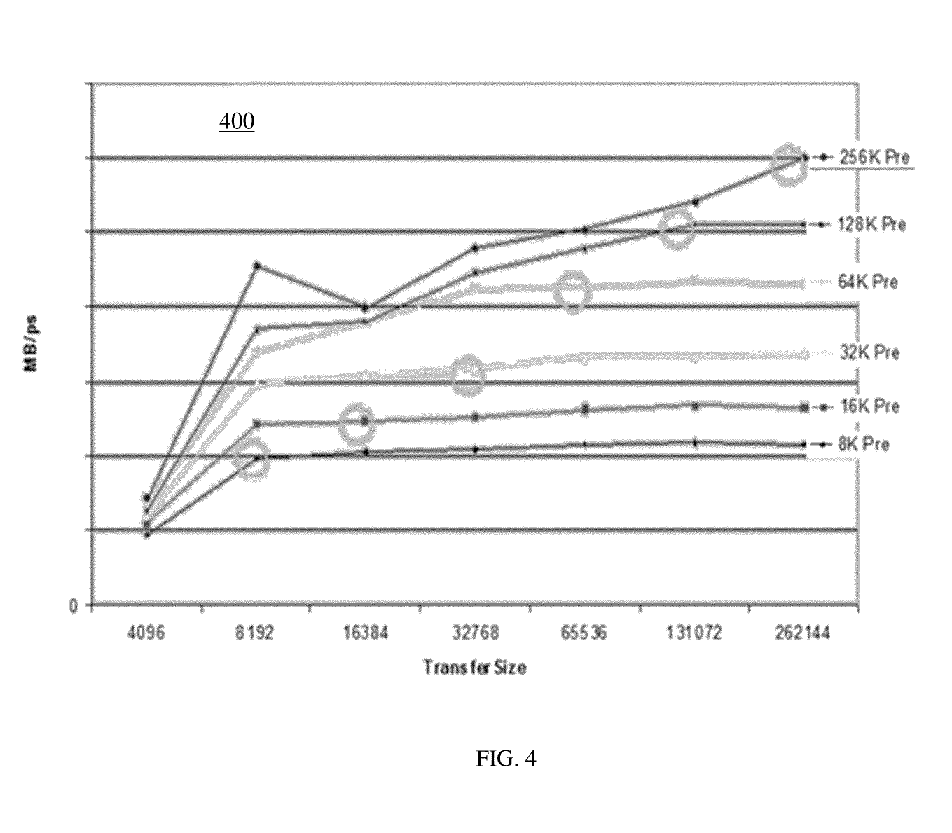

Referring now to FIG. 4, a graph 400 illustrating the effect of write block size on write operations in a flash device is shown. The graph illustrates the throughput in MB/sec of writing data to the flash device after the flash device has been pre-conditioned with writes over a period of time with various pre-condition block sizes. As illustrated, as the transfer block size of the data written to the flash device increases the write throughput of the flash device increases. Furthermore, the write throughput of the flash device is at a maximum when the flash device has been pre-conditioned with large block sizes of data.

As will be appreciated by one skilled in the art, one or more aspects of the present invention may be embodied as a system, method or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

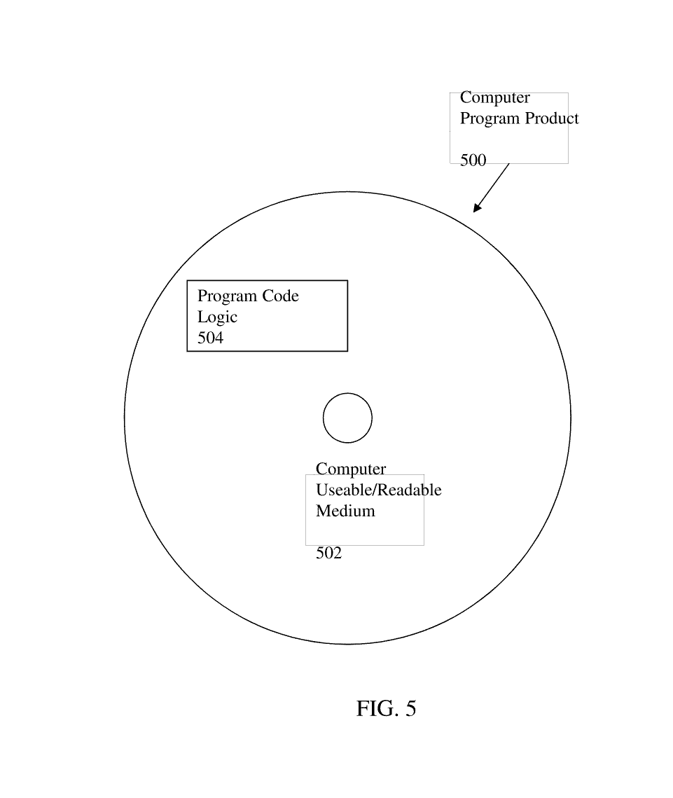

Referring now to FIG. 5, in one example, a computer program product 500 includes, for instance, one or more storage media 502, wherein the media may be tangible and/or non-transitory, to store computer readable program code means or logic 504 thereon to provide and facilitate one or more aspects of embodiments described herein.

Program code, when created and stored on a tangible medium (including but not limited to electronic memory modules (RAM), flash memory, Compact Discs (CDs), DVDs, Magnetic Tape and the like is often referred to as a “computer program product”. The computer program product medium is typically readable by a processing circuit preferably in a computer system for execution by the processing circuit. Such program code may be created using a compiler or assembler for example, to assemble instructions, that, when executed perform aspects of the invention.

Embodiments include a method, system, and computer program product for optimizing write performance of a flash device. Aspects include receiving a request to evict a plurality of pages from a main memory and determining a block size, such as the ideal block size, for the flash device. Aspects also include grouping the plurality of pages from the main memory into a move specification block, wherein a size of the move specification block is the ideal block size, and writing the move specification block to the flash device.

In one embodiment, the move specification block is written to contiguous address space on the flash device.

In one embodiment, aspects further include determining a virtual address for each of the plurality of pages.

In one embodiment, grouping the plurality of pages from the main memory into the move specification block includes identifying an address for a list of the addresses, an address for the plurality of pages in the flash device, and a number of entries in the list.

In one embodiment, grouping the plurality of pages from the main memory into the move specification block is based on a locality of reference of each of the plurality of pages.

In one embodiment, the block size is determined based on one or more operational characteristics of the flash device.

In one embodiment, all data writes to the flash device include data blocks of the block size.

Technical effects and benefits include methods and systems that organize data pages that are selected for eviction from main memory during page replacement, which leads to higher throughput and lower latency when the evicted data pages are written to a flash device.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application, and to enable others of ordinary skill in the art to understand the embodiments with various modifications as are suited to the particular use contemplated.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described above with reference to flowchart illustrations and/or schematic diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer system for optimizing write performance of a flash device, the system comprising:
a real storage manager configured to control a main memory;
an auxiliary storage manager in communication with the real storage manager, the auxiliary storage manager configured to control an auxiliary storage, the auxiliary storage device including the flash device, the system configured to perform a method comprising:
receiving a request to evict a plurality of pages from the main memory;
determining a block size for the flash device;
grouping the plurality of pages from the main memory into a move specification block, wherein a size of the move specification block is the block size; and
writing the move specification block to the flash device.

2. The computer system of claim 1, wherein the move specification block is written to contiguous address space on the flash device.

3. The computer system of claim 1, wherein the plurality of pages are identified by virtual addresses.

4. The computer system of claim 3, wherein grouping the plurality of pages from the main memory into the move specification block includes identifying an address for a list of the virtual addresses, an address for the plurality of pages in the flash device, and a number of entries in the list.

5. The computer system of claim 1, wherein grouping the plurality of pages from the main memory into the move specification block is based on a locality of reference of each of the plurality of pages.

6. The computer system of claim 1, wherein the block size is determined based on one or more operational characteristics of the flash device.

7. The computer system of claim 1, wherein all data writes to the flash device include data blocks of the block size.

8. A computer implemented method for optimizing write performance of a flash device, the method comprising:
receiving, by a processor, a request to evict a plurality of pages from a main memory;
determining an block size for the flash device;
grouping the plurality of pages from the main memory into a move specification block, wherein a size of the move specification block is the block size; and
writing the move specification block to the flash device.

9. The computer implemented method of claim 8, wherein the move specification block is written to contiguous address space on the flash device.

10. The computer implemented method of claim 8, wherein the plurality of pages are identified by virtual addresses.

11. The computer implemented method of claim 10, wherein grouping the plurality of pages from the main memory into the move specification block includes identifying an address for a list of the virtual addresses, an address for the plurality of pages in the flash device, and a number of entries in the list.

12. The computer implemented method of claim 8, wherein grouping the plurality of pages from the main memory into the move specification block is based on a locality of reference of each of the plurality of pages.

13. The computer implemented method of claim 8, wherein the block size is determined based on one or more operational characteristics of the flash device.

14. The computer implemented method of claim 8, wherein all data writes to the flash device include data blocks of the block size.

15. A computer program product for optimizing write performance of a flash device, the computer program product comprising:
a tangible storage medium readable by a processing circuit and storing instructions for execution by the processing circuit for performing a method comprising:
receiving, by a processor, a request to evict a plurality of pages from a main memory;
determining an block size for the flash device;
grouping the plurality of pages from the main memory into a move specification block, wherein a size of the move specification block is the block size; and
writing the move specification block to the flash device.

16. The computer program product of claim 15, wherein the move specification block is written to contiguous address space on the flash device.

17. The computer program product of claim 15, wherein the plurality of pages are identified by virtual addresses.

18. The computer program product of claim 17, wherein grouping the plurality of pages from the main memory into the move specification block includes identifying an address for a list of the virtual addresses, an address for the plurality of pages in the flash device, and a number of entries in the list.

19. The computer program product of claim 15, wherein grouping the plurality of pages from the main memory into the move specification block is based on a locality of reference of each of the plurality of pages.

20. The computer program product of claim 15, wherein the block size is determined based on one or more operational characteristics of the flash device.
